(19) United States
(12) Patent Application Publication
(10) Pub. No.: US 2016/0175178 A1
(43) Pub. Date: Jun. 23, 2016

(54) DEVICES AND METHODS FOR ACTIVE HEAD STABILIZATION DURING SURGERY

(71) Applicant: Novartis AG, Basel (CH)

(72) Inventor: Steven T. Charles, Memphis, TN (US)

(21) Appl. No.: 14/572,864

(22) Filed: Dec. 17, 2014

(51) Int. Cl. A61G 13/12

(52) U.S. Cl. CPC A61G 13/121

(57) ABSTRACT

A method and device for actively stabilizing a patient during ocular surgery includes one or more sensors attached to a patient to measure motion, a head stabilization member, and one or more actuators that actively offset the motion of a patient.

### FIELD OF THE INVENTION

The present disclosure pertains to devices and methods for head stabilization during a surgical procedure. More particularly, but not by way of limitation, the present disclosure pertains to devices and methods for actively stabilizing a patient's head during ocular surgery.

### BACKGROUND

Microsurgical procedures frequently require precision cutting and/or removing various body tissues. Due to the delicate nature of these procedures, patients must remain very still during surgery. Even small movements can lead to complication or injury, especially to the delicate cornea, lens, and retina. Patients may exhibit problematic voluntary and involuntary motion due to stress, fatigue, sedation, or medical conditions. Additionally, respiratory motion is especially problematic in some procedures such as anterior segment, posterior segment, and refractive surgeries. These procedures typically require the patient to lie in a supine position for an extended period. Where a patient suffers from sleep apnea, obesity, congestive heart failure, or chronic obstructive pulmonary disease, respiratory function may be inhibited, leading to greater body motion.

For instance, patients without respiratory issues generally engage in diaphragmatic breathing which causes relatively little motion. However, obesity may cause the diaphragms to be pushed upward by abdominal fat, restricting normal breathing patterns. The restriction may necessitate thoracic rib cage breathing which causes discomfort and increased body motion. In particular, thoracic rib cage breathing activates the sternocleidomastoid muscles which are attached to the skull and the sternum. With every breath, these muscles lift up the ribcage and pull the head back and forth, causing rhythmic, pitch axis head motion. In addition, patients that are over-sedated or those with sleep apnea may exhibit sudden head motion upon awakening during surgery, thereby endangering the eye. Other patients have musculoskeletal pain or motion disorders such as Parkinson's disease or anxiety causing them to suddenly move during surgery. Patients also commonly rotate their heads about their neck axis when anxious.

Traditionally, positioning devices for ocular surgery are designed to completely immobilize a patient's head. These devices are often made from stiff materials and either encircle the head of a patient or attach directly to a patient's head. Use of rigid devices over an extended period can lead to patient discomfort and fatigue. Some patients may experience increased levels of anxiety, nausea, or claustrophobia. Additionally, a patient that suddenly moves while in contact with a rigid device can experience potentially injurious compression on vulnerable areas of the head.

A need exists for both reduced head motion during surgery as well as increased patient comfort. The present invention is directed to addressing these deficiencies in the prior art.

### SUMMARY

According to an exemplary aspect, the present disclosure is directed to an active head stabilizing system for minimizing movement of the head of a patient during a surgical procedure. The system may include a head stabilization member arranged to support the head of a patient. The head stabilization may include one or more actuators attached to the head stabilization member in a position to engage against the forehead and the back of the head of the patient when the head stabilization member encircles the head of the patient. The actuators may be controllable via an actuator control signal. The system also may include one or more motion sensors arranged to detect motion of the patient and to communicate a motion signal, and may also include a controller arranged to receive the motion signal as an input from the one or more motion sensors and arranged to output the actuator control signal to the one or more actuators based on the input from the one or more motion sensors to actively stabilize the head of the patient by offsetting motion detected by the one or more motion sensors.

In an aspect, the one or more actuators are electromechanical linear actuators. In an aspect, the one or more actuators are inflatable balloons. In an aspect, the one or more inflatable balloons are arranged to be inflated and deflated by pneumatic or hydraulic valves.

According to another exemplary aspect, the present disclosure is directed to a method of stabilizing a head of a patient during ocular surgery. The method includes disposing the head of the patient in a head stabilization member, detecting motion of the patient with one or more motion sensors, engaging a forehead and a back of the head of the patient with the one or more actuators, receiving data from the one or more motion sensors, and outputting signals to the one or more actuators based on the received data to actively stabilize the forehead of the patient by offsetting motion detected by the one or more motion sensors.

According to another exemplary aspect, the present disclosure is directed to an active head stabilizing system that includes a head stabilization member for minimizing movement of the head of a patient during a surgical procedure. The head includes a frame arranged to at least partially encircle the head of a patient, and includes one or more actuators attached to the frame in a position to engage against the head of the patient when the frame encircles the head of the patient. The actuators may be controllable via an actuator control signal. The system also includes one or more motion sensors arranged to be attached to the patient and to communicate a motion signal, and includes a console comprising a user interface and a control system that receives the motion signal as an input from the one or more motion sensors and outputs the actuator control signal to the one or more actuators based on the input from the one or more motion sensors to actively stabilize the forehead of the patient by offsetting motion recorded by the one or more motion sensors.

### BRIEF DESCRIPTION OF THE DRAWINGS

The accompanying drawings illustrate embodiments of the devices and methods disclosed herein and together with the description, serve to explain the principles of the present disclosure.

FIG. 1 is an illustration of an exemplary active head stabilizing system in a surgical environment according to an aspect of the present disclosure implementing the principles and methods described herein.

FIG. 2 is a block diagram of an exemplary embodiment of a portion of an active head stabilizing system according to an aspect of the present disclosure.

FIG. 3 is a block diagram of an exemplary embodiment of a portion of an active head stabilizing system according to an aspect of the present disclosure.

FIG. 4 is an illustration of a portion of another exemplary active head stabilizing system according to an aspect of the present disclosure implementing the principles and methods described herein.

FIG. 5 is a flow chart showing an exemplary method of stabilizing a head of a patient during a surgical procedure according to an aspect of the present disclosure implementing the principles and methods described herein.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For simplicity, in some instances the same reference numbers are used throughout the drawings to refer to the same or like parts.

In some exemplary aspects, the present disclosure is directed to an active head stabilizing system usable during a surgical procedure, such as an ocular surgical procedure, to maintain the head in a relatively fixed or stable position, while still providing comfort for the patient. By monitoring actual patient movement, the system actively operates to counteract and arrest potentially dangerous movement while providing a more natural-feeling and comfortable experience for patients undergoing ocular surgery. Actively operating during the surgical procedure to dampen or reduce motion is different than rigidly restraining the head in a fixed location so that the head is immoveable through all or a portion of a surgery. Active controlling occurs by changing actuation in real-time in response to information relating to patient movement and thereby opposing the motion of a patient.

In some aspects, the active head stabilizing system includes a head collar that extends around the patient's head and sensors that detect patient movement. In response to detected motion or in response to detected changes in the patient, the active head stabilizing system controls actuators that physically displace to counteract patient motion to more completely stabilize the head during the procedure. As such, the head is held in a more stable position than in unrestrained surgeries with more patient comfort than in rigid, fixed restraining structures. The reduced motion can result in better physician control of instruments and tools while minimizing patient restraint, contributing to better patient outcome.

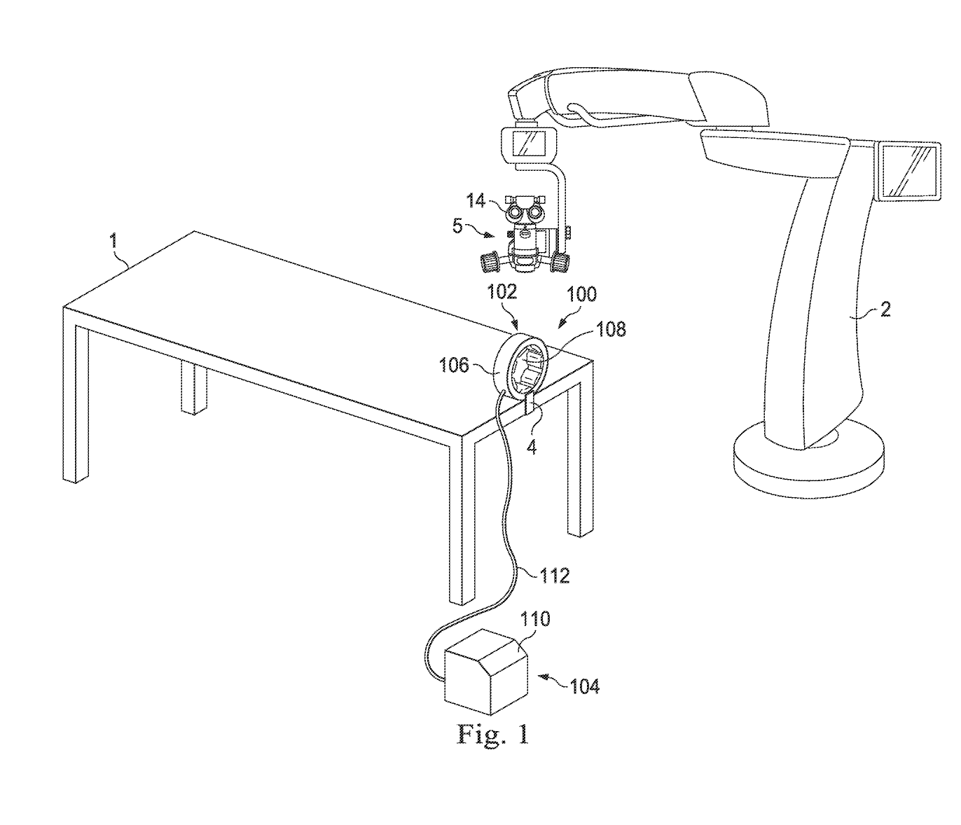

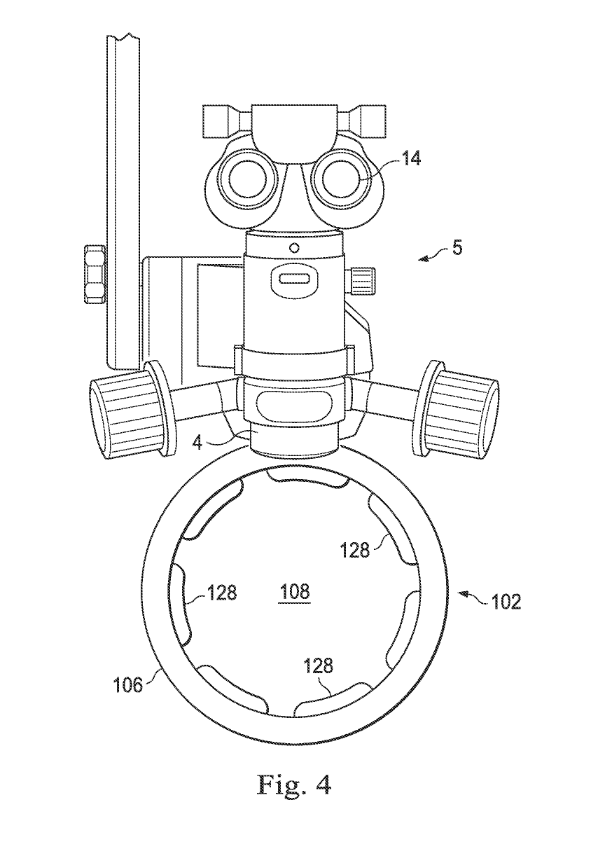

FIG. 1 illustrates an active head stabilizing system 100 and a surgical arrangement according to an exemplary embodiment. The active head stabilizing system 100 includes a head stabilization member 102, a control console 104, and one or more motion sensors (shown in FIG. 3 as sensors 105) that may be attached directly to the patient, the head stabilization member 102, or at some other location about the surgical arrangement. In embodiments herein, the head stabilization member 102 includes an outer frame 106, here shown as a collar, and an actuator array 108 disposed within and carried on the outer frame 106. The head stabilization member 102 may be in communication with a control system 110 housed in the console 104 or elsewhere. FIG. 1 shows the head stabilization member 102 connected to the console 110 by means of a communication cable 112. The communication cable 112 may be an electrical cable that carries signals and communications between the control system 110 in the control console 104 and the head stabilization member 102. However, it should be apparent that in some embodiments, wireless communication between the console 104 and the head stabilization member 102 may be used. Here, a surgical microscope 5 is attached to a floor stand 2 and suspended above the operating table 1.

In this configuration, an ophthalmologist may perform surgery on a patient lying supine on the operating table 1. In general, an ophthalmologist performs ocular surgery while looking through the eyepieces 14 of the microscope 5 or at a magnified image of the patient's eye. The active head stabilizing system 100 is designed to reduce patient motion, such as motion that occurs as a result of natural breathing, throughout the surgical procedure to avoid injury to the patient or damage to the equipment. In some instances, the ophthalmologist rests a portion of his or her hands on the patient's head as he or she performs the surgery in an attempt to coordinate his or her own movement with that of the patient. This technique also may be used with the head stabilization member 102 in place. Furthermore, the head stabilization member 102 may lend additional stability to the ophthalmologist-patient contact by counteracting the unfavorable motions of both the patient and ophthalmologist and providing stable operating conditions.

In the example shown in FIG. 1, a connector 4 anchors the head stabilization member 102 to the operating table 1. The connector 4 may create a stable base for the head stabilization member 102. Such a stable base may help to arrest involuntary patient movement. In some embodiments, the connector 4 is adjustable to set the stabilization member 102 at a desired height above the operating table 1 in order to optimize patient comfort and actuator efficiency.

Still referring to FIG. 1, the outer frame 106 of the head stabilization member 102 partially or fully encircles the patient's head. In some embodiments, this outer frame is circular or semi-circular in shape and may be made of a rigid material such as plastic or metal strong and rigid enough to counter or arrest patient head movement during a surgical procedure. The frame 106 also functions as a support structure for the actuator array 108 carried thereon which actively and dynamically counteracts patient motion.

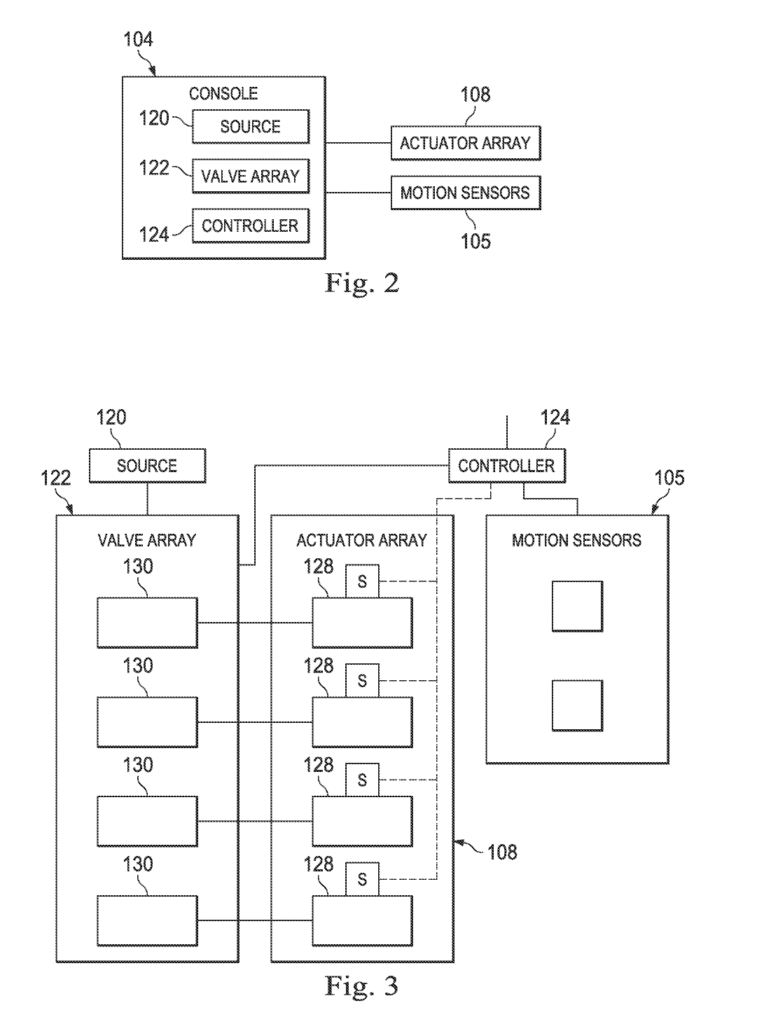

FIG. 2 is a block diagram showing the console 104, the actuator array 108, and the motion sensors 105 according to one exemplary embodiment. In this embodiment, the console 104 comprises a fluid source 120, a valve array 122, and a controller 124. The valve array 122 and the controller 124 may form a part of the control system 110. The fluid source 120 and the valve array 122, under the control of the controller 124, may be used to actively actuate individual actuators (shown as actuators 128 in FIG. 3) of the actuator array 108 and prevent or limit head movement of the patient. The controller 124 may be used to control individual valves (shown as valves 130 in FIG. 3) of the valve array 122. In embodiments where the actuators 128 are electrically actuated, the control console 104 may include the controller 124, which may communicate directly with electrical actuators 128 of the actuator array 108 instead of the valves 130 of the valve array 122. In some embodiments, the console 104 also includes a user interface that receives inputs from and/or provides information and data to a user. Through the user interface, the user may be able to activate the active head stabilizing system, receive diagnostic information relating to the system or the patient, and perform other tasks.

The fluid source 120 may be a source of a pressurized fluid. In some examples, it is a pressurized gas source such as air or nitrogen, and may include, for example, a compressed tank, a compressor, or other gas source that may be used to provide a fluid to the valve array 122. This fluid is used to actuate the actuators 128. In some embodiments, the fluid source 120 is a tube or valve which delivers gas or fluid from an external source connected with the console 104 (such as hospital pressurized gas). Alternatively, the source 120 is a liquid source that may be disposed within the control console 104 itself or that may be controlled through the console 104. Having a fluid source self-contained within the console 104 may enhance the portability of the active head stabilizing system 100. The fluid source 120 may be connected to the valve array 122 by a connection within the console 104.

The valve array 122 may consist of a plurality of individual valves 130, such as for example, pneumatic three-way valves that open and close to both inflate and vent fluid from the actuators 128 of the actuator array 108. For example, in some embodiments, the actuators are balloons that actively inflate or deflate to counter movement of the patient's head. The balloon actuators may be inflated by a fluid, such as liquid or gas, to counter motion of the patient. A system employing gas to actuate the actuators 128 may be used for the benefit of adding a spring term or cushion effect to the control law based on the compressibility of air, thus reducing the effects of direct compression on the patient and increasing comfort. Alternatively, a water-based system using hospital water pressure may be used instead of air pressure to more precisely offset patient motion. In this case, the water temperature may be controlled to optimize patient comfort. Proportional valves in combination with motion sensors 105 could be used to adjust pressure in individual actuators 128 both for active stabilization and for patient comfort.

In the embodiments shown in FIGS. 2 and 3, the controller 124 is also connected to the valve array 122 and controls the valves 130 to open, close, or otherwise regulate the flow of fluid or gas delivered by the source 120 to the actuator array 108. The controller 124 may include a processor or FPGA (Field-programmable gate array) and memory, with the processor as an integrated circuit with power, input, and output pins capable of performing logic functions, or is a controller that controls different components that perform different functions. This controller 124 analyzes sensor data and sends signals to the actuators 128 of the head stabilization member 102 to actively and dynamically reduce motion. In some embodiments, the controller 124 uses an algorithm employing logic control or an alternative learning based control to produce these signals. The memory may be a semiconductor memory that interfaces with the processor. In one example, the processor can write to and read from the memory. For example, the processor can be configured to read data from the sensor system and write that data to the memory. In this manner, the controller 124 can generate signals based on data or executable programs stored in the memory to control the active head stabilizing system 100. The controller 124 may also perform other basic functions, such as erasing or overwriting the memory, detecting when the memory is full, and other common functions associated with managing semiconductor memory.

The actuator array 108 is made up of a plurality of individual actuators 128 (FIG. 1) that, in some embodiments, are actuatable independent of one another. The actuators 128 may be fastened to the inside surface or periphery of the outer frame 106. The actuators 128 may also contact the patient's head when the patient's head is disposed within the head stabilization member 102. The actuators 128 engage the patient's head in specified areas, such as the forehead or back of the head, to provide additional stability. In one embodiment, actuators 128 are positioned and arranged to contact both the forehead and the back of the head of a patient. Additionally, the actuators 128 may be positioned to contact the patient on both sides of the head near the temples to facilitate corrective motion in three or more axes.

The actuators 128 are configured and arranged to engage the patient's head and, under the control of the control system 110, counter or arrest movement of the patient's head that would occur during the surgical procedure. In some embodiments, to provide a level of patient comfort, each actuator 128 is covered in a compressible material such as foam or gel. In some embodiments, the actuators 128 are adhered to or removably attached to a patent's head through the use of adhesives. This may provide a more secure connection to increase stability and immobility. In another embodiment, each actuator 128 may be connected to a cushioning or compressible material such as, for example, a strip of cloth or a rubber or foam ring encircling the patient's head. The use of such a strip or ring may help to alleviate compression on the patient's head and coordinate movement between the actuators 128.

In one embodiment, the actuators 128 are electromechanical linear actuators operable under the control of the controller 124. In another embodiment, the actuators 128 are pneumatic or hydraulic actuators that facilitate precise position control under the control of the control system 110. In some embodiments, the controller 124 or control system 110 may be configured to compensate for dampening or spring effects that come as a result of padding in order to produce better active stabilization.

In another embodiment, the actuators 128 are a set of expandable pad-like balloons configured as a head rest or cushion. The balloon actuators may partially or completely encircle a patient's head. The balloon actuators may be connected to the valve array 122 (FIG. 2) via multiple tubing segments or multi-lumen co-extruded tubing.

The motion sensors 105 that form a part of the active head stabilizing system 100 are configured to detect movement by the patient and send signals to the controller 124 that indicate the movement. In one embodiment, the sensors 105 that measure or detect the position or motion of a patient are removably fastened to a patient. These sensors 105 may include, for example, vibrating structure gyroscopes (e.g. MEMS (Microelectromechanical systems) three-axis gyroscopes), accelerometers, or other types of motion detecting sensors. The sensors 105 may be attached to a patient's body using adhesives or held on with a fastening strap or other tension device. Depending on the approach, the sensors 105 may be attached to the forehead to measure the pitch and roll of the neck, to the back of the head to measure more generalized motion, or other location about the head of the patient. An array of sensors 105 may be attached to several locations on a patient's head for position triangulation purposes. These may be disposed on the sides of the head, the forehead, the chin or facial area, back of the head, or neck, for example. Sensors 105 may also be placed on a stable surface, such as the operating table 1, to provide accurate position data in relation to the sensors 105 attached to the patient. Alternatively, the motion sensors 105 may include a machine vision target and one or more imaging devices such as cameras or lasers. The position of the target may then be recorded by the cameras or tracked by the lasers to provide precise motion data.

FIG. 3 is a detailed block diagram of a portion of the active head stabilizing system 100 according to an exemplary embodiment utilizing the valve array 122 and the actuator array 108. The controller 124 is in communication with the motion sensors 105, individual valves of the valve array 122, and sensors, such as flow sensors or pressure sensors on the individual actuators of the actuator array 108. The controller 124 may be programmed or arranged to control the valve array 122 based on feedback or other information from the motion sensors 105 and/or the actuator array 108. In general, the controller 124 receives inputs, such as data or information from the motion sensors 105 which are attached to a patient. After analyzing the inputs, the controller 124 sends control signals to the valve array 122 to control its operation. Feedback directly from the actuators 128 or from sensors 132 on the actuators 128 may be used to calculate position of the actuator, volume, pressure, or flow, among other data that may be used to control the valves 130. The source 120 of fluid or gas is connected to the valve array 122. In response to signals from the controller 124, the valves 130 of the valve array 122 open or close to send an appropriate amount of fluid or gas to the actuators of the actuator array 108. In some instances, each valve in the valve array 122 is connected to a separate actuator 128 in the actuator array 108. The actuators 128 may be inflatable balloons. The sensors 132 may be attached directly to the actuators 128 or may be disposed nearby. The sensors 132 provide feedback to the controller 124 to ensure that the correct adjustments have been made by the actuators 128 to counteract the motion of the patient. In one embodiment, the internal sensors may be flow sensors that check the fill levels of the balloons to avoid overfilling. The sensors 132 may also measure the temperature of fluid or gas in the balloons. In another embodiment, the internal sensors 132 are motion sensors. With this sensor redundancy, the controller 124 may be able to compare the readings between the internal sensors 132 and the motion sensors 105 attached to the patient to make sure that the patient is immobilized.

FIG. 4 shows another embodiment of the head stabilization member 102 wherein the stabilization member 102 is connected to the surgical microscope 5. The surgical microscope 5 is attached to the floor stand 2 (FIG. 1). An example of a surgical microscope 5 is the Q-VUE Ophthalmic Microscope and an example of a floor stand 2 is the LuxOR LX3, each manufactured by Alcon Laboratories, Inc. In the configuration shown in FIG. 4, the ophthalmologist can easily manipulate the surgical microscope 5 to an ideal height above the patient. Mechanical stabilizing devices may be implemented in the surgical microscope 5 or floor stand 2 for additional stability. The stabilization member 102 may be connected to the surgical microscope 5 by an adjustable connector 4. This connector 4 allows the stabilization member 102 to be set at a particular distance from the surgical microscope 5 to facilitate patient comfort and optimize actuator efficiency. A direct connection between the stabilization member 102 and the surgical microscope 5 may center the surgical microscope 5 on the surgical area and allow an ophthalmologist to see more clearly in the event of residual patient motion. Furthermore, mounting the head stabilization member 102 on a surgical microscope which is in turn connected to an adjustable floor stand 2 allows for easy positioning of the head stabilization member 102 before surgery and facilitates adjustments to the head stabilization member 102 during surgery. Actuators 128 are connected to the stabilization member 102 and may contact the patient's head.

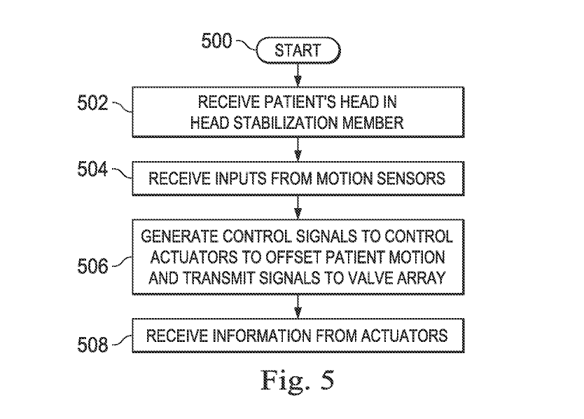

Operation of the active head stabilizing system 100 is described below with reference to a flow chart show in FIG. 5. The method begins at 500, and at 502 the patient's head is received within the head stabilization member 102. The head may be fit in many ways, including in the manner described in the paragraphs herein. At 504, the controller 124 receives inputs from the motion sensors 105. The motion sensors may be disposed directly on the patient, such as on the patient's head, or may be cameras of other motion detecting system disposed about the operating room. The motion sensors 105 are arranged and configured to detect motion, including direction of movement, and can generate signals communicating information about the movement to the controller 124. In some embodiments, the sensors are configured to detect motion of the surgical site, such as motion on the eye itself. In other embodiments, the motion sensors are strain or load sensors arranged to detect changes in loading that indicate movement or loading changes on the patient's head. The inputs received at the controller 124 from the motion sensors 105 may include data or information relating to the motion.

The controller 124 processes the inputs received from the motion sensors and at 506 generates and communicates control signals for the actuators 128. The control signals control the actuators to counter or arrest movement of the patient's head in order to actively reduce motion at the surgical site. In some embodiments, the actuators are actively controlled to counter, limit, or reduce motion during diaphragmatic breathing. This may be accomplished by the controller's 124 manipulation of the valve array 122 to send an appropriate amount of fluid or gas to inflate or vent the balloons of the actuator array 108. In another embodiment, the controller 124 sends signals directly to electromechanical actuators 128 within the actuator array 108 to offset motion recorded by the sensors 105. In some embodiments, the appropriate amount of fluid or gas to send or the amount of offset motion to use may be pre-determined through modeling and/or iterative sampling and analysis. For example, various sizes of the balloons at various pressures (and/or gas/fluid volumes) may be measured and the results used to form a look-up table or equation that can then be used by the controller to determine a corresponding amount of fluid or gas to add or remove (e.g., based on valve position) for the necessary inflation or deflation of the balloon to counter the detected motion. In some embodiments, a PID (proportional-integral-derivative) controller that uses motion sensor feedback to determine a difference between the actual head motion/position and the desired head motion/position (e.g., 0) may be used to iteratively add or remove fluid or gas to reach the desired head motion/position.

Accordingly, in some examples, when the patient is inhaling, the actuators may be controlled to counter-load the patient's head to maintain the surgical site in a relatively stable position. As the patient exhales, the actuators may be controlled to reduce the counter-load on the patient's head so that the patient's head is maintained with less movement than when free and preferably in a relatively stable position. Accordingly, the system actively controls the actuators during the surgical procedure to dampen or reduce motion, and in some embodiments, nearly maintain the head in a non-moving position by actively countering motion. This is different than rigidly restraining the head in a fixed location so that the head is immoveable through all or a portion of a surgery. Active controlling occurs through real-time adjustment of load to compensate for motion of the body, including the natural motion of the body. That is, under the control of the control system 110, the actuators 108 engage or apply active loading in real-time to oppose the motion of a patient and keep the patient's head more stable based on data collected by a number of sensors 105.

In some cases, the head stabilization member 102 may exhibit a slight amount of lag in counteracting the patient's movement due to the processing time of the controller as well the actuator response time. This slight amount of lag may be favorable in several ways. First, a slightly delayed actuator response may help to cushion the patient's head by reducing compressive forces. Second, a slight delay built into the system may help to simulate the natural slight motions which many ophthalmologists are accustomed to working with. Third, in contrast to static systems which produce no motion information, the controller may be able to gather and compile information from the sensors on lag time to better understand involuntary patient motion and produce more effective algorithms for arresting motion.

At 508, sensors on the actuators provide information to the controller 124. The sensors may provide information relating to the actuator itself For example, the sensor may provide feedback to the controller relating to the actuator position, the inflation level of the actuator when the actuator is inflatable, the pressure applied by the actuator against the patient's head, or other information. In some embodiments, the information may be utilized by the controller to dictate or determine a control strategy for the actuators.

Persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

I claim:

1. An active head stabilizing system for minimizing movement of the head of a patient during a surgical procedure, comprising:
a head stabilization member arranged to support the head of a patient, the head stabilization comprising:
one or more actuators attached to the head stabilization member in a position to engage against the forehead and the back of the head of the patient when the head stabilization member encircles the head of the patient, wherein the actuators are controllable via an actuator control signal;
one or more motion sensors arranged to detect motion of the patient and to communicate a motion signal; and
a controller arranged to receive the motion signal as an input from the one or more motion sensors and arranged to output the actuator control signal to the one or more actuators based on the input from the one or more motion sensors to actively stabilize the head of the patient by offsetting motion detected by the one or more motion sensors.

2. The active head stabilizing system of claim 1, wherein the head stabilization member is affixed to an operating table.

3. The active head stabilizing system of claim 1, wherein the head stabilization member is affixed to a surgical microscope.

4. The active head stabilizing system of claim 1, wherein the one or more motion sensors are attached to the head of the patient.

5. The active head stabilizing system of claim 4, wherein the one or more motion sensors are attached to a facial area of the patient's head.

6. The active head stabilizing system of claim 1, wherein the one or more actuators are electromechanical linear actuators.

7. The active head stabilizing system of claim 1, wherein the one or more actuators are inflatable balloons.

8. The active head stabilizing system of claim 7, wherein the one or more inflatable balloons are arranged to be inflated and deflated by pneumatic or hydraulic valves.

9. The active head stabilizing system of claim 7, wherein the one or more inflatable balloons are arranged to be inflated with pressurized gas.

10. The active head stabilizing system of claim 7, wherein the one or more inflatable balloons are arranged to be inflated with a liquid.

11. A method of stabilizing a head of a patient during ocular surgery comprising:
disposing the head of the patient in a head stabilization member;
detecting motion of the patient with one or more motion sensors;
engaging a forehead and a back of the head of the patient with the one or more actuators;
receiving data from the one or more motion sensors; and
outputting signals to the one or more actuators based on the received data to actively stabilize the forehead of the patient by offsetting motion detected by the one or more motion sensors.

12. The method of claim 11, wherein the one or more actuators are electromechanical linear actuators.

13. The method of claim 11, wherein the one or more actuators are inflatable balloons.

14. The method of claim 13, wherein the one or more inflatable balloons are inflated and deflated by pneumatic or hydraulic valves.

15. The method of claim 13, wherein the one or more inflatable balloons are inflated with pressurized gas.

16. The method of claim 13, wherein the one or more inflatable balloons are inflated with a liquid.

17. An active head stabilizing system, comprising:
a head stabilization member for minimizing movement of the head of a patient during a surgical procedure, comprising:
a frame arranged to at least partially encircle the head of a patient, and
one or more actuators attached to the frame in a position to engage against the head of the patient when the frame encircles the head of the patient, wherein the actuators are controllable via an actuator control signal;
one or more motion sensors arranged to be attached to the patient and to communicate a motion signal; and
a console comprising a user interface and a control system that receives the motion signal as an input from the one or more motion sensors and outputs the actuator control signal to the one or more actuators based on the input from the one or more motion sensors to actively stabilize the forehead of the patient by offsetting motion recorded by the one or more motion sensors.

18. The head stabilizing system of claim 17, wherein the one or more actuators engage against the forehead and the back of the head of the patient when the head stabilization member encircles the head of the patient.

19. The head stabilizing system of claim 17, wherein the one or more actuators are electromechanical linear actuators.

20. The head stabilizing system of claim 17, wherein the one or more actuators are inflatable balloons.
